(19) United States
(12) Patent Application Publication
(10) Pub. No.: US 2024/0333437 A1
(43) Pub. Date: Oct. 3, 2024

(54) Direct Access To Storage Device Via Switch Data Plane

(71) Applicant: Microsoft Technology Licensing, LLC, Redmond, WA (US)

(72) Inventors: Wenxue CHENG, Beijing (CN); Ziyuan LIU, Beijing (CN); Yongqiang XIONG, Beijing (CN); Zhixiong NIU, Beijing (CN); Peng CHENG, Beijing (CN); Lihua YUAN, Redmond, WA (US); Jacob NELSON, Redmond, WA (US); Dan PORTS, Redmond, WA (US)

(21) Appl. No.: 18/293,852

(22) PCT Filed: Jul. 22, 2022
(86) PCT No.: PCT/US2022/037956

§ 371 Date: Jan. 31, 2024

(30) Foreign Application Priority Data
Aug. 6, 2021 (CN) 202110901026.3

(51) Int. Cl. H04L 1/1867; H04L 47/34

(52) U.S. Cl. CPC H04L 1/1867; H04L 47/34

(57) ABSTRACT

Some implementations relate to direct access to a storage device using a data plane of a switch. A response signal for a first packet transmitted from the switch to the storage device is received from a storage device. The first packet encapsulates a packet sequence number and first data to be transmitted by the switch. The response signal contains the packet sequence number. If the response signal is a negative acknowledgement response signal, a first state sequence number of the switch is updated with the packet sequence number contained in the response signal. The first state sequence number represents a sequence number of a packet to be transmitted by the switch. The first state sequence number and second data to be transmitted by the switch are encapsulated in a second packet to be transmitted to the storage device.

### BACKGROUND

With the development of computing and network technologies, numerous Big-Data-based analytic applications have their roles in today's production environment. In general, the workflow of the analytic applications can be divided into two phases: collecting data and analyzing. In the ideal case, since new information is not generated during data collection, it is expected to apply as much available computing resource as possible in the analyzing phase while spending the least computing resource during data collection, to minimize the cost. Nonetheless, in the real case, considerable resource may be consumed in the data collection phase.

### SUMMARY

In accordance with a plurality of implementations of the subject matter as described herein, there is provided a solution for accessing a storage device via a data plane of a switch. At a data plane of the switch, a response signal for a first packet transmitted from the switch to the storage device is received from a storage device, where the first packet encapsulates a packet sequence number and first data to be transmitted by the switch, and the response signal contains the packet sequence number. In response to determining that the response signal is a negative acknowledgement response signal, a first state sequence number of the switch is updated with the packet sequence number included in the response signal, where the first state sequence number represents a sequence number of a packet to be transmitted by the switch. The first state sequence number and second data to be transmitted by the switch are encapsulated in a second packet, and the second packet is transmitted to the storage device.

The Summary is to introduce a selection of concepts in a simplified form that are further described below in the Detailed Description. This Summary is not intended to identify key features or essential features of the subject matter as described herein, nor is it intended to be used to limit the scope of the subject matter as described herein.

### BRIEF DESCRIPTION OF THE DRAWINGS

FIG. 1 illustrates a block diagram of a data collection system that can implement a plurality of implementations of the subject matter as described herein;

FIG. 2 illustrates a block diagram of a switch in accordance with some implementations of the subject matter as described herein;

FIG. 3 illustrates a flowchart of a method of establishing a connection in accordance with some implementations of the subject matter as described herein;

FIG. 4 illustrates a flowchart of a packet encapsulation method in accordance with some implementations of the subject matter as described herein;

FIG. 5 illustrates a schematic diagram of a “black hole” state;

FIG. 6 illustrates a flowchart of a control-plane implemented method in accordance with some implementations of the subject matter as described herein;

FIG. 7 illustrates a flowchart of a method of processing a response signal in accordance with some implementations of the subject matter as described herein;

FIG. 8 illustrates a flowchart of a retransmission method in accordance with the prior art;

FIG. 9 illustrates a flowchart of a retransmission method in accordance with some implementations of the subject matter as described herein;

FIG. 10 illustrates a flowchart of a transmission completion processing method in accordance with some implementations of the subject matter as described herein;

FIG. 11 illustrates a flowchart of a control-plane implemented method in accordance with some implementations of the subject matter as described herein;

FIG. 12 illustrates a mapping table between logical addresses and physical addresses in accordance with some implementations of the subject matter as described herein;

FIG. 13 illustrates a schematic diagram of an append operation in accordance with some implementations of the subject matter as described herein; and

FIG. 14 illustrates a flowchart of a method in accordance with some implementations of the subject matter as described herein.

Throughout the drawings, the same or similar reference symbols refer to the same or similar components.

### DETAILED DESCRIPTION OF EMBODIMENTS

The subject matter as described herein will now be discussed with reference to several example implementations. It is to be understood that these implementations are discussed only for the purpose of enabling those skilled in the art to better understand and thus implement the subject matter as described herein, rather than suggesting any limitations on the scope of the subject matter as described herein.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, either explicit or implicit, may be included below.

A loss-tolerant application is an application that is not sensitive to loss of data to be processed. For example, some data analytic applications focus on mining out useful semantics from the statistics of data and therefore are not sensitive to loss of data. Examples of these applications include a packet-mirror-based telemetry system (e.g. EverFlow, NetSight, and the like) and a logging analysis system (e.g. an audit log of a search engine). In accordance with implementations of the subject matter as described herein, direct access to a storage device is implemented using a data plane of a switch in a loss-tolerant application. When a transmission error occurs in a packet, a sequence number in the packet may be used to encapsulate or package the next packet to be transmitted, so as to satisfy the requirements of reliable transmission. In this way, the subject matter as described herein can save computing resources and thus lower the requirements on the computing resources during the data collection phase without considering the problem of data loss. Reference now will be made to the drawings to describe various implementations of the subject matter.

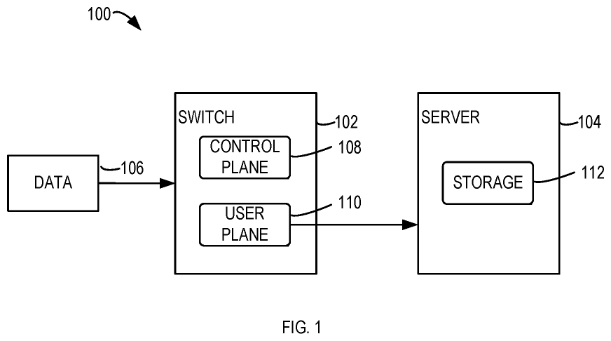

FIG. 1 illustrates a schematic diagram of a data collection system 100 in accordance with some implementations of the subject matter as described herein. As shown in FIG. 1, the data collection system 100 includes a switch 102 and a server 104 in communication with the switch 102. The server 104 includes a storage device 112 which may be any appropriate storage device such as a flash, hard drive, and the like. The switch 102 may be a programmable switch and includes a control plane 108 and a data plane 110. The switch 102 may receive a packet 106 from various data sources and transmit the packet 106 to the server 104 for processing. For example, those data sources may be selected from a log of a search engine, and the like. For example, the server 104 may include a Remote Direct Memory Access (RDMA) Network Interface Card (RNIC) for enabling communication between the storage device 112 and the data plane 110 of the switch 102. The switch 102 may be a programmable switch, for example, a P4 programmable switch.

Non-Volatile Memory express (NVMe) transmission refers to a non-volatile memory based transmission specification, which intends to provide reliable storage access and data transmission, for example, via a PCIe bus and the like. Based on the transmission via a PCIe bus and the like, network storage of the data center can be supported via an NVMe (NVMe over Fabric, NVMe-oF) extension. A RDMA-supporting fabric structure may be selected from InfiniBand (IB), RDMA over Converged Ethernet (RoCE), Internet Wide Area RDMA Protocol (iWARP) and the like. The implementations of the subject matter will be described mainly in connection with those scenarios. However, it would be appreciated that the implementations may also be applied to any other appropriate standards or protocols.

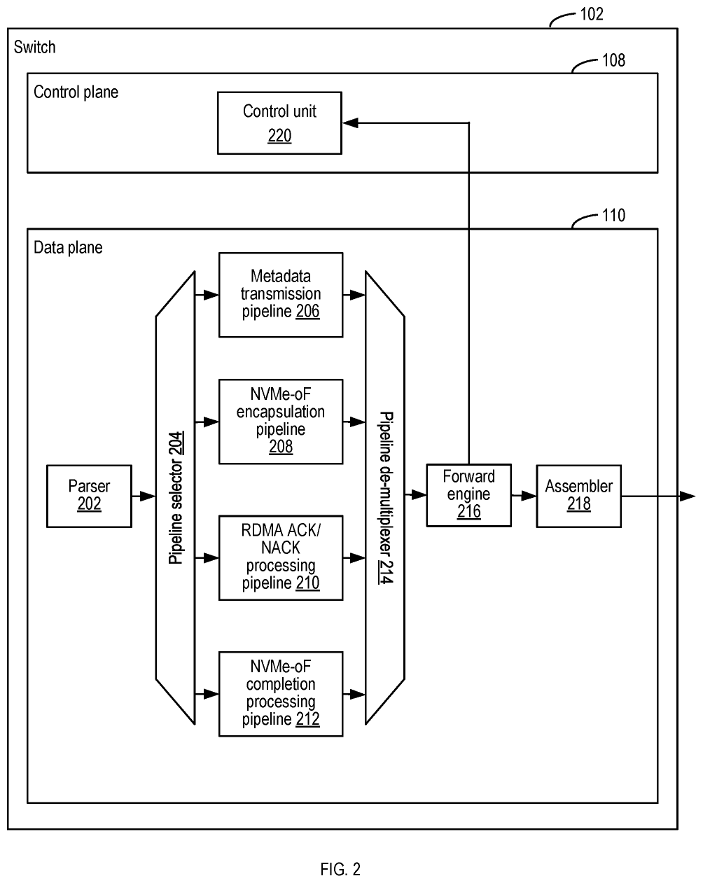

FIG. 2 illustrates a block diagram of the switch 102 in accordance with some implementations of the subject matter as described herein. As shown in FIG. 2, the control plane 108 of the switch 102 includes a control unit 220 which may be used to execute various operations of the control plane 108. The data plane 110 of the switch 102 include a parser 202 for parsing the packet 106 received from a data source. In some implementations, the data plane 110 may be implemented in the form of hardware, such as Field Programmable Gate Arrays (FPGAs), Application-Specific Integrated Circuit (ASIC), and the like. In the programmable switch, the data plane 110 can be programmed to implement various functions.

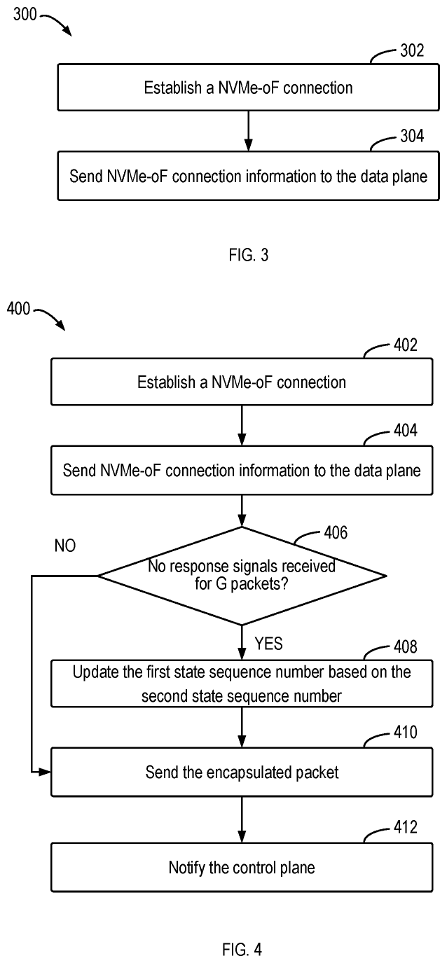

As shown in FIG. 2, the parser 202 transmits the parsed packet 106 to a pipeline selector 204, and the pipeline selector 204 forwards, based on the type of the packet 106, the packet 106 to different pipelines, such as a metadata transmission pipeline 206, a NVM3-oF package pipeline 208, a RMDA ACK/NACK pipeline 210, and a NVMe-oF completion responding processing pipeline 212. For example, if it is determined that the packet 106 is metadata, the pipeline selector 204 transmits the packet 106 to the metadata transmission pipeline 206. The pipelines can process the packet 106 correspondingly, and then forward the processed packet to a pipeline demultiplexer 214. The pipeline demultiplexer 214 transmits the packet to a forwarding engine 216. Depending on a destination address in the packet, the forwarding engine 216 may transmit the packet to the control unit 220 within the packet 108, or to an assembler 218. The assembler 218 assembles the packet in a predetermined format so as to transmit the latter to the server 104. Hereinafter, reference will be made to FIGS. 3-12 to describe operations of the pipelines 206-212. FIG. 3 illustrates a flowchart of a method 300 of establishing a connection between a switch and a storage device in accordance with some implementations of the subject matter as described herein. For example, the method 300 may be executed at the control plane 108 of the switch 102 as shown in FIGS. 1 and 2, to establish a NVME-oF connection between the switch 102 and the storage device 112. For example, the method 300 may be implemented through software in the control plane 108 of the switch 102.

At block 302, an NVMe-oF connection is established between the switch 102 and the storage device 112. For example, an NVMe connection and an RDMA reliable connection (RC) are established between the switch 102 and the storage device 112, respectively, to establish the NVMe-oF connection between the switch 102 and the storage device 112. For example, after the NVMe connection and the RDMA RC connection are established, metadata exchange can be performed between the switch 102 and the storage device 112.

At block 304, after the NVMe-oF connection between the switch 102 and the storage device 112 is established, the control plane 108 of the switch 102 offloads the metadata, or supplies the metadata to the data plane 110 of the switch 102. For example, the control plane 108 may provide the metadata to the data plane 110 via an Application Programming Interface (API) of the data plane 110. Upon receiving the metadata, the data plane 110 can implement the function of encapsulating or packaging a packet based on the received metadata.

FIG. 4 illustrates a flowchart of a method 400 of encapsulating a packet in accordance with some implementations of the subject matter as described herein. For example, the method 400 may be implemented at the NVMe-oF encapsulation pipeline 208 as shown in FIG. 2.

For example, the switch 102 can receive data 106, such as an EverFlow packet, from one or more data sources. At block 402, based on a first state sequence number of the switch 102, the data received by the switch 102 from the data source are encapsulated or packaged in a packet, for example, a NVMe-oF packet. For the RDMA RC type, reliable transmission can be achieved using a Packet Sequence Number (PSN) field in an IB Base Transport header. In order to achieve reliable transmission, the switch 102 needs to maintain the state sequence number, representing the sequence number of the packet to be transmitted (also referred to as Packet Sequence Number, PSN). Otherwise, the packet transmitted by the switch 102 is probably rejected by the RNIC at the server 104.

In some implementations, the first state sequence number may be maintained by the data plane 110 of the switch 102, which represents the sequence number of the packet to be transmitted.

For example, the data 106 and the first state sequence number are encapsulated as part of the NVMe-oF packet. In some implementations, the data plane 110 of the switch 102 may include a plurality of virtual interfaces, such as Queue Pairs (QPs). For example, a first state sequence number are maintained for each virtual interface. For ease of discussion, description will be made with reference to one QP, but it would be appreciated that the method described herein can be applied to any other QP(s).

In some implementations, based on the RDMA over Converged Ethernet version 2 (RoCEv2) and NVMe-oF specification, a valid packet includes headers such as an Ethernet header, Internet Protocol (IP) header, User Datagram Protocol (UDP) header, IB Base Transport header, NVMe command capsule, and the like. The metadata for crafting those headers can be acquired through a metadata offloading process as illustrated at block 304 in FIG. 3. For example, the metadata can include metadata of each Queue Pair (QP), such as a QP Number (QPN), a Packet Sequence Number (PSN), and the like. Although the metadata specified according to the RoCEv2 are provided herein as an example, corresponding metadata can be supplied according to any other appropriate specification.

At block 404, the first state sequence number is incremented by 1. In this way, the updated first state sequence number can be used for encapsulating the next packet.

At block 406, it is determined whether the switch does not receive any response signal for a predetermined number of packets subsequent to a packet for which a most recent response signal has been received. For convenience, G is used to denote the predetermined number, which is also referred to as a threshold value. The response signal herein includes an Acknowledge response signal (ACK) and a Negative Acknowledgement response signal (NACK).

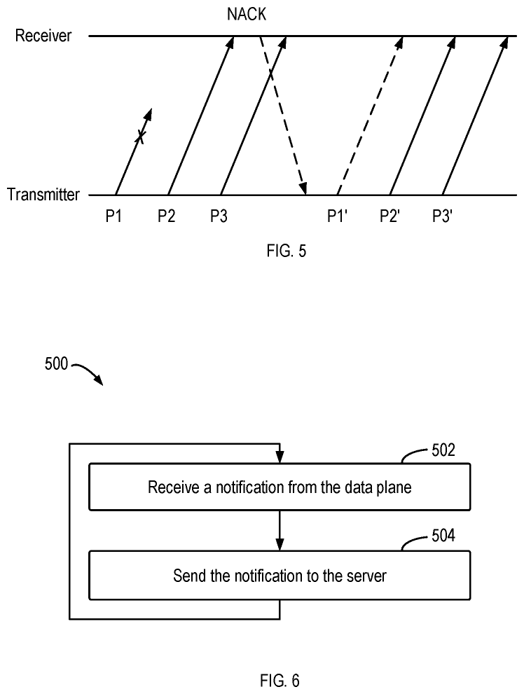

If it is determined at block 406 that the switch does not receive any response signal for G packets subsequent to the packet for which the most recent response signal has been received, it can be determined that the receiver is currently at a “black hole” state as shown in FIG. 5. In the “black hole” state, the receiver discards all packets, without transmitting any feedback to the transmitter. As shown in FIG. 5, the transmitter sequentially transmits three packets P1, P2, and P3, where the packet P1 is lost during transmission. Upon receiving the packet P2, the receiver determines, based on the sequence number in the packet P2, that the packet P1 is lost. Then, the receiver discards the packet P2 and transmits NACK for the packet P1 to the transmitter. When the packet P3 arrives at the receiver, the receiver discards the packet P3 without sending any feedback because the receiver has transmitted a NACK. Upon receiving the NACK, the transmitter retransmits three packets P1′, P2′, and P3′. If the packet P1′ is successfully received, the receiver will prepare for receiving subsequent packets including P2′ and P3′. However, if NACK is received or P1′ is lost, the receiver will trap into a “black hole” state until receiving the packet P1.

If it is determined at block 406 that the switch does not receive any response signal for the predetermined number of packets subsequent to the packet for which the most recent response signal has been received (i.e., a “black hole” state), the method 400 proceeds to block 408. At block 408, the first state sequence number is updated based on a second state sequence number, where the second sequence number represents a sequence number of the packet for which the most recent acknowledgement response signal has been received. The second state sequence number may be maintained by the data plane 110 of the switch 102. For example, the packet encapsulated at block 402 can be regarded as the first packet subsequent to the packet for which the most recent acknowledgement response signal has been received. Therefore, the first state number may be reset to a second state number plus one (1). Then, the method 400 proceeds to block 410 where the switch 102 transmits the encapsulated packet to the storage device 112.

If it is determined at block 406 that it is not the case that the switch does not receive any response signal for the predetermined number of packets subsequent to the packet for which the most recent response signal has been received, the method 400 proceeds to block 410. At block 410, the switch 102 transmits the encapsulated packet to the storage device 112. In this way, in the data plane 110 of the switch 102, the problem of trapping into the “black hole” state can be solved.

In some implementations, a counter may be relied on to determine whether the switch does not receive any response signal for the predetermined number of packets subsequent to the packet for which the most recent response signal has been received, thereby determining whether a “black hole” state has been entered. In order to count the number of packets that have been transmitted, the counter can be increased by one every time when a packet is transmitted. In addition, if a response signal (ACK or NACK) is received, the counter will be reset to 0. Therefore, when the counter reaches a predetermined number or threshold value (G), it can be determined that the switch does not receive any response signal for the predetermined number of packets subsequent to the packet for which the most recent response signal has been received. Otherwise, when the counter does not reach a predetermined number or threshold value (G), it can be determined that it is not the case that the switch does not receive any response signal for the predetermined number of packets subsequent to the packet for which the most recent response signal has been received.

At block 412, if necessary, the data plane 110 of the switch 102 can notify the control plane 108 of the switch 102. In some implementations, the control plane 108 of the switch 102 may be notified via a data amount based notification mechanism. For example, the data plane 110 of the switch 102 may maintain a counter which represents the number of packets that have been transmitted. If the counter reaches a threshold value, the control plane 108 of the switch 102 will be notified. The server 104 is not capable of determining the amount of data received by the storage device 112. Therefore, upon receiving the notification of the data plane 110, the control plane 108 of the switch 102 may send a message to the server 104 to notify the server 104 that the amount of the received data has reached the threshold value. At this time, the server 104 has acquired enough data and thus can perform subsequent processing on the data. Hereinafter, reference will be made to FIG. 6 to describe the subsequent processing of the corresponding notification.

FIG. 6 illustrates a flowchart of a method 500 implemented by the control plane 108 of the switch 102 in accordance with some implementations of the subject matter as described herein. For example, the method 500 can be implemented by the control plane 108 of the switch 102.

At block 502, the control plane 108 of the switch 102 receives a notification sent by the data plane 108 of the switch 102. As described above with reference to block 412 of FIG. 4, the notification may be a predetermined number of data transmissions performed from the switch 102 to the storage device 112. Alternatively or additionally, the notification may be a predetermined period of time for which a data transmission is performed from the switch 102 to the storage device 112.

At block 504, the control plane 108 of the switch 102 sends a notification to the server 104. Upon receiving the notification, the server 104 can process the data received by the storage device 112. Since the storage device 112 directly participates in the data transmission process but the processor of the server 104 does not, the server 104 cannot acquire when the data transmission is completed, when data processing is started, and the like. By means of the method 500, the server 104 can acquire the above information for subsequent data processing.

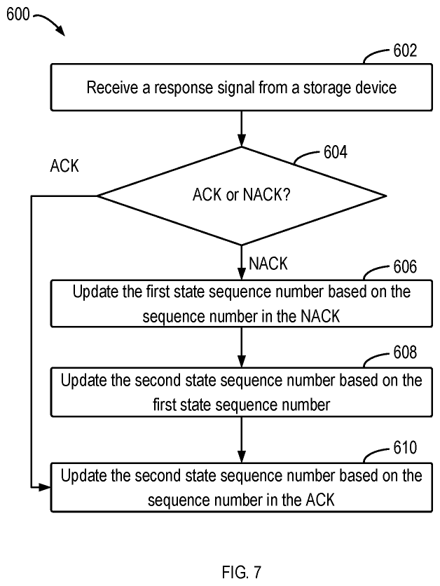

FIG. 7 illustrates a flowchart of a method 600 of processing a response signal in accordance with some implementations of the subject matter as described herein. For example, the method 600 may be implemented by the RDMA ACK/NACK processing pipeline 210 as shown in FIG. 2.

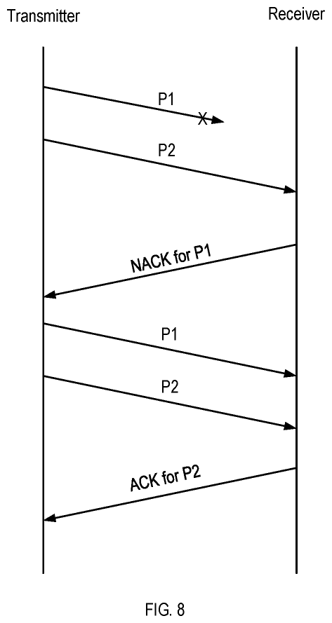

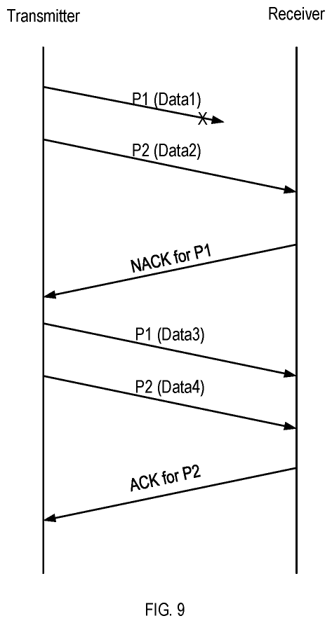

At block 602, the data plane 110 of the switch 102 receives a response signal from the storage device 112. At block 604, the data plane 110 of the switch 102 determines whether the response signal is an acknowledgement signal (ACK) or a negative acknowledgement signal (NACK). If it is determined at block 604 that the response signal is NACK, at block 606, the data plane 110 of the switch 102 updates or resets the first state sequence number of the switch 102 based on the sequence number contained or specified in the NACK. Reference will be made to FIGS. 8 and 9 to further describe block 606 below.

In general, RDMA accomplishes reliable data transmission using a Priority Flow Control (PFC) mechanism. However, in some circumstances, some packets may still be dropped by the RDMA Network Interface Card (RNIC) due to invalid checksum caused by bit-error. Moreover, a RDMA receiver may also reject some packets due to insufficient resource. In those cases, the RDMA receiver may transmit, to the RDMA transmitter, NACK containing an expected PSN of a next packet to be transmitted by RDMA. Then, the RDMA transmitter needs to trigger a go-back-N retransmission mechanism to implement retransmission.

FIG. 8 illustrates a go-back-N retransmission mechanism in accordance with the prior art. As shown in FIG. 8, upon receiving the packet P2, the receiver finds that the packet P1 has not been received and thus determines a receiving failure of the packet P1. In the circumstance, the receiver returns a NACK response corresponding to the packet P1 to the transmitter. At this time, the transmitter needs to sequentially retransmit the packets P1 and P2. However, due to the limitation of hardware of the switch 102, it is difficult for the switch 102 to store data in the retransmitted packets.

FIG. 9 illustrates a schematic diagram of a retransmission method in accordance with some implementations of the subject matter as described herein to satisfy the requirements of the RDMA reliable transmission. As shown in FIG. 9, data in the packet P1 and the packet P2 are data 1 and data 2, respectively. Upon receiving the NACK response corresponding to the packet P1, the transmitter still transmits the packets P1 and P2, but the data in the packets P1 and P2 are updated as data 3 and data 4, respectively. Because data loss is acceptable in loss-tolerant applications, the implementations of the subject matter as described herein tolerate loss of data 1 and data 2 during transmission. As such, the switch 102 does not need to store data in the retransmitted packets and can support RDMA reliable transmission.

For example, in the example of FIG. 9, the response signal corresponding to the packet P1 is NACK containing the sequence number of the packet P1 where the sequence number is the expected sequence number of the next packet to be transmitted. The first state sequence number is reset to a sequence number contained or specified in the NACK for retransmitting the packet P1, where the packet P1 has the same sequence number as the original packet P1 but contains different data than the latter.

Returning to FIG. 7, at block 608, the second state sequence number is updated based on the first state sequence number. The packet corresponding to the acknowledgement signal received recently is the previous one of the packet responded with the NACK, and the second state sequence number of the packet corresponding to the acknowledgement signal received recently is updated as subtracting 1 from the first state sequence number.

If it is determined at block 604 that the response signal is ACK, the second state signal is updated at block 610, based on the sequence number contained or specified in the ACK. For example, the second state sequence number may be updated as the sequence number contained or specified in the ACK.

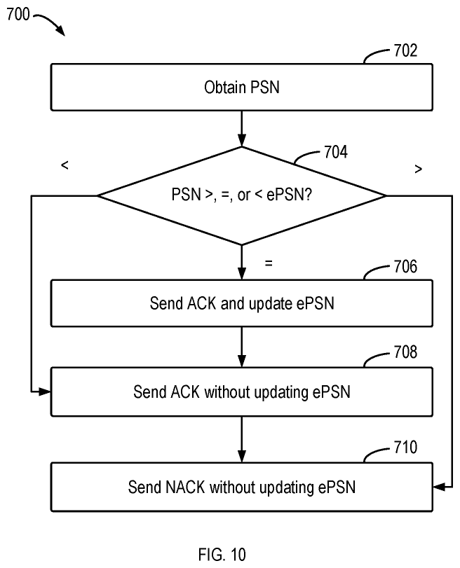

FIG. 10 illustrates a flowchart of a transmission completion processing method 700 in accordance with some implementations of the subject matter as described herein. For example, the method 700 can be implemented by the NVMe-oF completion response processing pipeline 212 as shown in FIG. 2.

After completing execution of the NVMe command, the storage device 112 transmits an NVMe-oF completion packet to the switch 102. Since the RDMA-supporting NVMe-oF data transmission is established on RDMA RC, from the RDMA's perspective, the NVMe completion packet is just a payload and needs a response from the switch 102. Therefore, the switch 102, as a receive terminal of the RDMA QP of the storage device 112, needs to maintain the expected sequence number of the RDMA QP of the storage device 112, which may be represented as ePSN.

At block 702, upon receiving the NVMe-oF completion packet, the switch 102 acquires a QP number (QPN) and a Packet Sequence Number (PSN) corresponding to the QP.

At block 704, it is determined whether PSN is greater than, equal to, or less than ePSN. If it is determined at block 704 that PSN is equal to ePSN, at block 706, the switch 102 transmits an acknowledgement signal to the storage device 112 and updates ePSN (e.g. increasing ePSN by 1). For example, an ACK packet can be built by adding an appropriate header and truncating the received payload.

If it is determined at block 704 that PSN is less than ePSN, at block 708, the switch 102 sends an acknowledgement response to the storage device 112 but does not update the ePSN. If it is determined at block 704 that PSN is greater than ePSN, at block 710, the switch 102 sends a negative acknowledgement response signal to the storage device 112 but does not update the ePSN. For example, a NACK packet can be built by adding an appropriate header and truncating the received payload.

The NVMe-oF completion packet carries a status of the storage device 112. If necessary, the data plane 110 of the switch 102 may transmit to the control plane 108 a notification on the status of the storage device 112. For example, the data plane 110 may examine the NVMe-oF completion packet to determine the status of the storage device 112. If the control plane 110 of the switch 102 determines that the status of the storage device 112 is abnormal (e.g. disconnected or the like), the data plane 110 of the switch 102 may notify the control plane 108 of the switch 102.

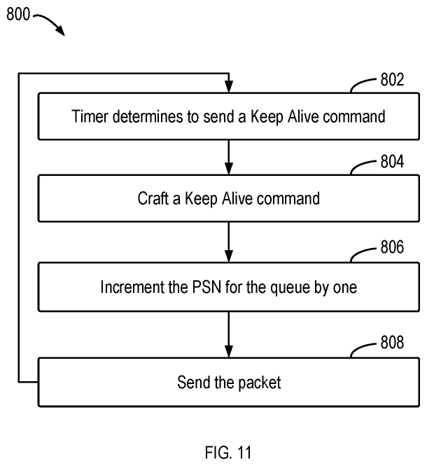

FIG. 11 illustrates a flowchart of a method 800 of maintaining a connection between the switch 102 and the storage device 112 in accordance with some implementations of the subject matter as described herein. For example, the method 800 can be implemented by the control plane 108 of the switch 102.

In some implementations, a Keep Alive command may be transmitted periodically based on a timer, to guarantee that the RDMA connection between the switch 102 and the storage device 112 is in a normal state. For example, according to the RDMA-supporting NVMe-oF specification, it is required to support a Keep Alive command. The transmission frequency for the Keep Alive command is kept low (e.g., every few seconds), thereby avoiding occupying too much resource of the control plane.

At block 802, in response to expiry of the timer, the switch 102 determines to transmit the Keep Alive command. The timer can be triggered periodically, where the period can be a few seconds, for example.

At block 804, the switch 102 creates a Keep Alive command, for example, via queues in an Admin Queue according to the NVMe protocol.

At block 806, the Packet Sequence Number (PSN) of the system queue is increased by 1. At block 808, the packet of the Keep Alive command is transmitted to the server 104 to notify the latter that the connection therebetween is valid and further prevent the latter from disconnecting and releasing resource.

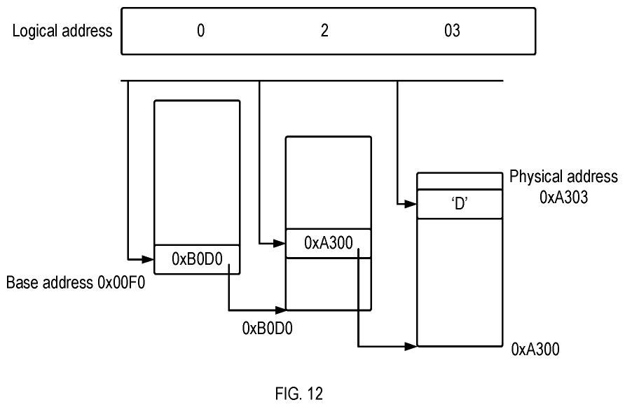

In accordance with a plurality of implementations of the subject matter as described herein, the switch receives data from a data source and stores the data in a remote storage device. The channel from the data source to the remote storage device can be abstracted as a logic flow. The data source appends data to the logic flow, where the data contain a corresponding logical address in the logic flow. In addition, when the data from the data source are encapsulated in a packet, the switch can dynamically allocate a physical address to the data. For example, the physical address may be a physical address according to the NVMe protocol. The switch can maintain a register in the data plane for indexing a next physical address of the data received from the data source to be stored, encapsulate the data and the corresponding physical address thereof in a packet, and transmit the packet to the remote storage device. For example, the remote storage device can parse the physical address of the data according to the NVMe protocol and store the data at a corresponding location. FIG. 12 illustrates a schematic diagram of mapping between a logical address and a physical address in accordance with some implementations of the subject matter as described herein. Mapping between the logical address and the physical address can be implemented through a multilevel page table. In the example of FIG. 12, a two-level page table is taken as an example for describing the mapping between a logical address and a physical address. It would be appreciated that other multilevel page tables may also be employed to implement mapping between the logical addresses and the physical addresses. By means of mapping between logical addresses and physical addresses, access to consecutive logical addresses and scattered physical addresses can be achieved, causing the physical storage space to be utilized more efficiently.

FIG. 12 illustrates an example of writing data D into a storage device based on a logical address 0x0203 in the logical flow. In the example as shown in FIG. 12, the logical address includes three offsets, where the first level offset is 0, the second level offset is 2, and the third level offset is 03. From the three offsets of the logical address and a base address (0x00F0), it can be determined that a corresponding physical address is 0xA303. More specifically, from the base address (0x00F0) of the logical flow and the first offset (0), a location of a first level page table entry can be determined, and the storage address (namely, 0xB0D0) can be read from the location. Then, the address 0xB0D0 in the first level page table entry is used as the base address. Based on the second level offset (2), the location of the second page table entry can be determined, and the storage address (namely, 0xA300) can be read from the location. Subsequently, based on the address 0xA300 and the third level offset (03), the final physical address can be determined as 0xA303, and the data “D” are stored at the physical address.

In some implementations, a data appending operation can be implemented based on a multilevel page table. The data plane of the switch 102 can include a plurality of registers for storing respective offsets of the multilevel page table to record the current storage status. For example, with respect to a two-level page table, the data plane of the switch 102 may include three registers for storing three offsets, respectively. Moreover, a multilevel page table can be stored in the storage device 112 of the server 104 to lower the requirements imposed on the storage capacity of the data plane of the switch 102.

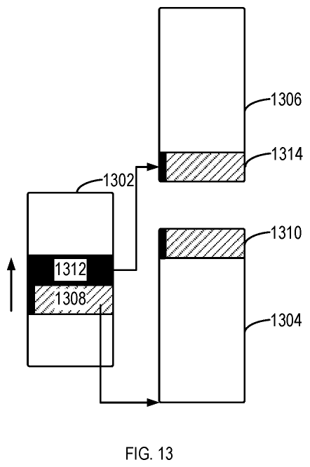

When the first offset or the second offset is moving, a new page table entry can be written into the storage device 112. Processing of metadata, such as page table entries and the like, can be implemented via the metadata transmission pipeline 206 as shown in FIG. 2. FIG. 13 illustrates a schematic diagram of a data appending operation in accordance with some implementations of the subject matter as described herein. As shown, it is assumed that the page entries corresponding to the rear end of the current logical flow logical address are the first level page entry 1308 and the second level page entry 1310. When the switch finds that the second page table 1304 is fully taken up after receiving next data, a new second level page table 1306 can be allocated, and a new page table entry 1312 can be allocated in the first level page table 1302 to store the base address of the second level page table 1306. Thereafter, the first second-level page entry 1314 of the second page table 1306 stores therein the physical address allocated to the data. At this time, the page entries corresponding to the rear end of the logical flow logical address include the first level page entry 1312 and the second level page entry 1314. In this way, the appending operation can be implemented. In the example, the new metadata entry can be written into the storage device 112, and the data plane of the switch 102 can be updated only in terms of offset.

In some implementations, the mirror function of the switch 102 can be applied to a packet to obtain a mirror packet. The packet can be transmitted to the storage device 112 via an encapsulation operation. In addition, the mirror packet is processed to determine the metadata (e.g. entries of the multilevel page table), and the metadata of the mirror packet is transmitted to the storage device 112.

The lower the generation frequency of a higher level metadata is, the greater the loss impact will be; the higher the generation frequency of a lower level metadata is, the less the loss impact will be. For example, data loss of an entry in a first level page table (a high level) in a multilevel page table probably causes all entries in the entire second level page table not available, thereby bringing about serious impact. In some implementations, the transmission strategy is varied with the level of the metadata. For example, with respect to a high level metadata (e.g. first level page table entries), reliable transmission may be performed by the control plane, such as a retransmission mechanism. With respect to a low level metadata (e.g., second level page table entries), the reliability can be improved through redundant transmission. For example, R entries are transmitted during each transmission, where R entries include 1 new entry and R−1 old entries. Suppose that the loss ratio is l and the probability of loss of level-2 metadata can be reduced to l^{R} by the redundant transmission solution. Furthermore, for the data per se, no special processing is required.

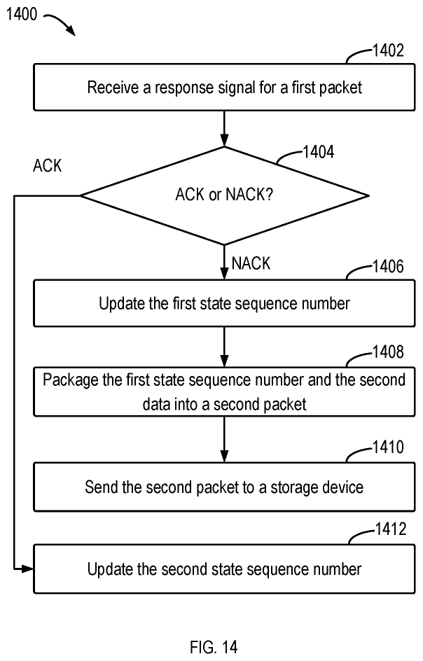

FIG. 14 illustrates a flowchart of a method 1400 in accordance with some implementations of the subject matter as described herein. The method 1400 can be implemented at the switch 102 as shown in FIG. 1 or 2.

At block 1402, the data plane of the switch receives from the storage device a response signal for a first packet transmitted from the switch to the storage device. The first packet encapsulates therein a packet sequence number and first data received by the switch from a data source. The response signal contains the packet sequence number.

At block 1404, the data plane of the switch determines whether the response signal is an acknowledgement signal or a negative acknowledgement signal.

If it is determined at block 1404 that the response signal is a negative acknowledgement signal, the method 1400 moves to block 1406 where the data plane of the switch updates a first state sequence number of the switch as a packet sequence number contained or specified in the response signal. The first state sequence number represents a sequence number of a packet to be transmitted by the switch.

At block 1408, the data plane of the switch encapsulates the first state sequence number and second data received by the switch from a data source in a second packet. For example, the switch can receive first data from the first data source and second data from the second data source, where the first data source may be identical to or different than the second data source.

At block 1410, the data plane of the switch transmits the second packet to the storage device.

In some implementations, the method 1400 further includes: determining, based on a logical address of second data, a physical address of the second data in the storage device via a multilevel page table. For example, as shown in FIG. 12, the logical address may be 0x0203, and the physical address may be 0xA303.

In some implementations, the logical address includes a plurality of offsets associated with the multilevel page table, where the plurality of offsets are stored in the data plane. For example, in the implementation of FIG. 12, the logical address includes three offsets which are stored in three registers, respectively.

In some implementations, the multilevel page table is stored in the storage device.

In some implementations, a high level page table entry in the multilevel page table is transmitted via a control plane of the switch.

In some implementations, a low level page table entry in the multilevel page table is transmitted through redundant transmission.

In some implementations, the method 1400 further includes: determining whether the switch does not receive any response signal for a predetermined number of packets subsequent to a packet for which a most recent response signal has been received; and in response to determining that the switch does not receive any response signal for the predetermined number of packets subsequent to the packet for which the most recent response signal has been received, updating the first state sequence number based on a second state sequence number of the switch, the second sequence number representing a sequence number of a packet for which a most recent acknowledgement response signal has been received. For example, the first state sequence number can be updated through blocks 406 and 408 as shown in FIG. 4.

In some implementations, the method 1400 further includes: in response to determining that the response signal is a negative acknowledgement response signal, updating a second state sequence number of the switch with the first state sequence number minus one, the second state sequence number representing a sequence number of a packet for which a most recent acknowledgement response signal has been received. For example, the second state sequence number is updated through the method as shown in block 608 in FIG. 7.

In some implementations, If it is determined at block 1404 that the response signal is an acknowledgement response signal, the method 1400 moves to block 1412 where the second state sequence number is updated with the packet sequence number contained or specified in the response signal. For example, the second state sequence number can be updated through the method as shown in block 610 in FIG. 7.

Some exemplary implementations of the subject matter as described herein will be listed below. In a first aspect, a method implemented at a switch is provided in the subject matter as described herein. The method comprises at a data plane of the switch: receiving, from a storage device, a response signal for a first packet transmitted from the switch to the storage device, the first packet encapsulating a packet sequence number and first data to be transmitted by the switch, and the response signal including the packet sequence number; in response to determining that the response signal is a negative acknowledgement response signal, updating a first state sequence number of the switch with the packet sequence number included in the response signal, the first state sequence number representing a sequence number of a packet to be transmitted by the switch; encapsulating the first state sequence number and second data to be transmitted by the switch in a second packet; and transmitting the second packet to the storage device.

In some implementations, the method further comprises determining, based on a logical address of the second data, a physical address of the second data in the storage device via a multilevel page table.

In some implementations, the logical address comprises a plurality of offsets associated with the multilevel page table, the plurality of offsets being stored in the data plane.

In some implementations, the multilevel page table is stored in the storage device.

In some implementations, a high level page table entry in the multilevel page table is transmitted via a control plane of the switch.

In some implementations, a low level page table entry in the multilevel page table is transmitted through redundant transmission.

In some implementations, the method further comprises determining whether the switch does not receive any response signal for a predetermined number of packets subsequent to a packet for which a most recent response signal has been received; and in response to determining that the switch does not receive any response signal for the predetermined number of packets subsequent to the packet for which the most recent response signal has been received, updating the first state sequence number based on a second state sequence number of the switch, the second sequence number representing a sequence number of a packet for which a most recent acknowledgement response signal has been received.

In some implementations, the method further comprises in response to determining that the response signal is a negative acknowledgement response signal, updating a second state sequence number of the switch with the first state sequence number minus one, the second state sequence number representing a sequence number of a packet for which a most recent acknowledgement response signal has been received.

In some implementations, the method further comprises in response to determining that the response signal is an acknowledgement response signal, updating a second state sequence number of the switch with the packet sequence number included in the response signal, the second state sequence number representing a sequence number of a packet for which a most recent acknowledgement response signal has been received.

In a second aspect, a switch is provided in the subject matter as described herein. The switch comprises: a data plane configured to receive, from a storage device, a response signal for a first packet transmitted from the switch to the storage device, the first packet encapsulating a packet sequence number and first data to be transmitted by the switch, and the response signal including the packet sequence number; in response to determining that the response signal is a negative acknowledgement response signal, update a first state sequence number of the switch with the packet sequence number included in the response signal, the first state sequence number representing a sequence number of a packet to be transmitted by the switch; encapsulate the first state sequence number and second data to be transmitted by the switch in a second packet; and transmit the second packet to the storage device.

In some implementations, the data plane is further configured to: determine, based on a logical address of the second data, a physical address of the second data in the storage device via a multilevel page table.

In some implementations, the logical address comprises a plurality of offsets associated with the multilevel page table, the plurality of offsets being stored in the data plane.

In some implementations, the multilevel page table is stored in the storage device.

In some implementations, a high level page table entry in the multilevel page table is transmitted via a control plane of the switch.

In some implementations, a low level page table entry in the multilevel page table is transmitted through redundant transmission.

In some implementations, the data plane is further configured to: determine whether the switch does not receive any response signal for a predetermined number of packets subsequent to a packet for which a most recent response signal has been received; and in response to determining that the switch does not receive any response signal for the predetermined number of packets subsequent to the packet for which the most recent response signal has been received, update the first state sequence number based on a second state sequence number of the switch, the second sequence number representing a sequence number of a packet for which a most recent acknowledgement response signal has been received.

In some implementations, the data plane is further configured to: in response to determining that the response signal is a negative acknowledgement response signal, update a second state sequence number of the switch with the first state sequence number minus one, the second state sequence number representing a sequence number of a packet for which a most recent acknowledgement response signal has been received.

In some implementations, the data plane is further configured to: in response to determining that the response signal is an acknowledgement response signal, update a second state sequence number of the switch with the packet sequence number included in the response signal, the second state sequence number representing a sequence number of a packet for which a most recent acknowledgement response signal has been received.

In a third aspect, an apparatus is provided in the subject matter as described herein. The apparatus comprises: a processing unit; and a memory coupled to the processing unit and having instructions stored thereon, the instructions, when executed by the processing unit, causing the apparatus to perform the method in accordance with the first aspect of the subject matter as described herein.

In a fourth aspect, a computer program product is provided in the subject matter as described herein. The computer program product is tangibly stored in a computer storage medium and comprising computer executable instructions which cause, when executed by an apparatus, the apparatus to perform the method in accordance with the first aspect of the subject matter as described herein.

In a fifth aspect, a computer readable storage medium is provided in the subject matter as described herein, which has computer executable instructions stored thereon. The computer executable instructions cause, when executed by an apparatus, the apparatus to perform the method in accordance with the first aspect of the subject matter as described herein.

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter as described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter as described herein, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A method implemented at a switch, comprising:
at a data plane of the switch:
receiving, from a storage device, a response signal for a first packet transmitted from the switch to the storage device, the first packet encapsulating a packet sequence number and first data to be transmitted by the switch, and the response signal including the packet sequence number;
in response to determining that the response signal is a negative acknowledgement response signal, updating a first state sequence number of the switch with the packet sequence number included in the response signal, the first state sequence number representing a sequence number of a packet to be transmitted by the switch;
encapsulating the first state sequence number and second data to be transmitted by the switch in a second packet; and
transmitting the second packet to the storage device.

2. The method of claim 1, further comprising:
determining, based on a logical address of the second data, a physical address of the second data in the storage device via a multilevel page table.

3. The method of claim 2, wherein the logical address comprises a plurality of offsets associated with the multilevel page table, the plurality of offsets being stored in the data plane;
wherein the multilevel page table is stored in the storage device; and
wherein a high level page table entry in the multilevel page table is transmitted via a control plane of the switch.

4. The method of claim 2, wherein a low level page table entry in the multilevel page table is transmitted through redundant transmission.

5. The method of claim 1, further comprising:
determining whether the switch does not receive any response signal for a predetermined number of packets subsequent to a packet for which a most recent response signal has been received; and
in response to determining that the switch does not receive any response signal for the predetermined number of packets subsequent to the packet for which the most recent response signal has been received, updating the first state sequence number based on a second state sequence number of the switch, the second sequence number representing a sequence number of a packet for which a most recent acknowledgement response signal has been received.

6. The method of claim 1, further comprising:
in response to determining that the response signal is a negative acknowledgement response signal, updating a second state sequence number of the switch with the first state sequence number minus one, the second state sequence number representing a sequence number of a packet for which a most recent acknowledgement response signal has been received.

7. The method of claim 1, further comprising:
in response to determining that the response signal is an acknowledgement response signal, updating a second state sequence number of the switch with the packet sequence number included in the response signal, the second state sequence number representing a sequence number of a packet for which a most recent acknowledgement response signal has been received.

8. A switch, comprising:
a data plane configured to
receive, from a storage device, a response signal for a first packet transmitted from the switch to the storage device, the first packet encapsulating a packet sequence number and first data to be transmitted by the switch, and the response signal including the packet sequence number;
in response to determining that the response signal is a negative acknowledgement response signal, update a first state sequence number of the switch with the packet sequence number included in the response signal, the first state sequence number representing a sequence number of a packet to be transmitted by the switch;
encapsulate the first state sequence number and second data to be transmitted by the switch in a second packet; and
transmit the second packet to the storage device.

9. The switch of claim 8, wherein the data plane is further configured to:
determine, based on a logical address of the second data, a physical address of the second data in the storage device via a multilevel page table.

10. The switch of claim 9, wherein the logical address comprises a plurality of offsets associated with the multilevel page table, the plurality of offsets being stored in the data plane; and wherein the multilevel page table is stored in the storage device.

11. The switch of claim 9, wherein a high level page table entry in the multilevel page table is transmitted via a control plane of the switch.

12. The switch of claim 9, wherein a low level page table entry in the multilevel page table is transmitted through redundant transmission.

13. The switch of claim 8, wherein the data plane is further configured to:
determine whether the switch does not receive any response signal for a predetermined number of packets subsequent to a packet for which a most recent response signal has been received; and
in response to determining that the switch does not receive any response signal for the predetermined number of packets subsequent to the packet for which the most recent response signal has been received, update the first state sequence number based on a second state sequence number of the switch, the second sequence number representing a sequence number of a packet for which a most recent acknowledgement response signal has been received.

14. The switch of claim 8, wherein the data plane is further configured to:
in response to determining that the response signal is a negative acknowledgement response signal, update a second state sequence number of the switch with the first state sequence number minus one, the second state sequence number representing a sequence number of a packet for which a most recent acknowledgement response signal has been received.

15. The switch of claim 8, wherein the data plane is further configured to:
in response to determining that the response signal is an acknowledgement response signal, update a second state sequence number of the switch with the packet sequence number included in the response signal, the second state sequence number representing a sequence number of a packet for which a most recent acknowledgement response signal has been received.
